(19) United States
(12) Patent Application Publication
(10) Pub. No.: US 2005/0258655 A1
(43) Pub. Date: Nov. 24, 2005

(54) Foldable frame for creating a scoop

(76) Inventors: Janet Matthews, Houston, TX (US); Tina Fincher, Houston, TX (US)

Correspondence Address: Justin Lampel, Esq., 2111 Primrose Lane, Schaumburg, IL, 60194, US

(21) Appl. No.: 10/847,921

(22) Filed: May 18, 2004

(51) Int. Cl. A01K 29/00; E01H 1/12

(52) U.S. Cl. 294/1.3; 294/55

(57) ABSTRACT

A foldable hand held scoop which is particularly suitable for picking up animal fecal waste. The scoop is formed from a substantially flat semi-rigid material, such as, for example, cardboard which may be easily folded into a functional configuration by utilizing score lines. In the flat configuration, the scoop may be easily transported and/or stored. The scoop has a bottom panel, a rear panel, two side panels, a handle and an opening section. Further, the scoop has a removable section that aids the user in scooping up the waste into the opening section of the scoop. The scoop may be inexpensive to manufacture and, therefore, suitable for disposal after one or few uses.

### BACKGROUND OF THE INVENTION

The present invention generally relates to a foldable frame for creating a scoop, and more particularly to a scoop which is ideal for picking up animal fecal waste. Further, the present invention relates to a scoop which is inexpensive and disposable. The foldable frame may be easy stored and/or transported in a flat configuration and subsequently folded into a functional scoop configuration prior to use.

A large number of family households have cats, dogs and/or other pets. Despite the joy these families receive from their pet(s), they are often left with the chore of cleaning up the waste from the pet. If the pet created the waste in a public area, such as a park, it is common that city laws or ordinances require the proper disposal of the animal's waste. If the animal created the waste on the owner's property, failure to clean up after the pet usually results in a diminished enjoyment of the owner's property.

People generally agree that cleaning up after a pet is not a pleasant experience. To accomplish this, people have implemented numerous devices, perhaps the most common of which is the standard shovel. A problem with using a standard shovel to clean up after a pet is that most people return the shovel to their garage or backyard with some remnants of the animal waste on the shovel. This practice may lead to an undesirable odor around the house as well as the creation of unhealthy living conditions. Further, if the owner decides to take the pet on a walk around the block, it is unpractical for the pet owner to bring a standard shovel along with a pet. Even further, the use of a standard shovel to clean up animal waste still leads to the problem of scooping the waste into the shovel without the shovel merely pushing the waste forward.

Alternatively, people often resort to cleaning up after the pet with a plastic bag. This practice, however, is also undesirable. The use of a plastic bag requires the owner to come into close contact with the animal's waste. Again, this may result in odor or disease passing from the waste to the human.

Further devices for picking up and disposing of an animal's waste include the use of plastic bags attached to scoops or thongs for picking up waste. However, these and other devices and methods are not convenient to use, fail to protect users from contamination by the waste, or have other disadvantages or drawbacks.

A need, therefore, exists for a foldable frame which coverts into a scoop which overcomes the foregoing problems and disadvantages. Further, a need exists for an improved animal waste scoop which may be stored in a flat configuration and easily folded into a functional configuration. A still further need exists for a scoop which is disposable.

### SUMMARY OF THE INVENTION

The present invention is directed toward a scoop for picking up and disposing of animal waste. More specifically, the scoop may be easy stored and or transported in a flat configuration and folded into the functional scoop prior to use. Further, the scoop may be made from a single substantially flat structure.

The scoop may be constructed from a semi-rigid material, such as, for example, cardboard, heavy duty paper or the like. The scoop may be inexpensively manufactured so as to allow disposal thereof after a single use. In a preferred embodiment, the scoop may be constructed of a biodegradable material.

Ideally, the scoop may be transported in a flat configuration and may be generally likewise stored in the flat configuration prior to use. Because the scoop may be transported and/or stored in a flat configuration, the scoop may be suitable for sale in a vending machine, for example, at a rest area, in a park or at a pet store.

The scoop may be easily folded into the functional configuration by almost anyone in under one minute. Further, to aid the user in the folding of the scoop, folding directions may be printed directly on the scoop. As a result, the user may not have to worry about loosing the folding directions. The folding of the scoop from the flat configuration into the functional configuration may be aided by numerous score lines in the semi-rigid material. The score lines allow the folding of the material without compromising the durability of the functional scoop.

A removable front section of the scoop may be separated from the scoop and aid the user into pushing the waste into the main scoop opening. As a result, the user may easily move the waste into the scoop without directly contacting the waste. After the waste is in the scoop, the removable front section, the waste and the scoop may then be disposed of in the proper manner.

The rear section of the functional scoop has a durable handle capable of supporting the scoop filled with waste. In addition, the handle has a hole for hanging the scoop in the flat or functional configuration. Still further, hole in the handle may be used to secure a plastic bag into the handle.

The scoop is suitable for use not only outside in, for example, a yard, sidewalk or park, but also may be used indoors in, for example, a litter box. Further, the scoop may be made of a material suitable for scooping up liquids in, for example, a litter box. More specifically, the scoop may be treated with a chemical which resists the absorption of liquids.

To this end, in an embodiment, a novel device is provided. The device is a foldable frame for forming a scoop. The foldable frame has a first section having a first edge, a second edge, a front edge and a back edge. The foldable frame also has a second section attached to the front edge of the first section wherein the second section is separated from the first section by a score line and wherein the second section has a top surface. Still further, the foldable frame has a main handle section attached to the back edge of the first section and a first side panel and a second side panel attached to the second section. Finally, the frame has a removable section attached to the second section wherein the removable section is separated from the second section by a score line and wherein the removable section is completely removed from the second section and is used to scoop material onto the top surface of the second section.

In an embodiment, the foldable frame has an opening in the main handle section.

In an embodiment, the foldable frame has an opening in the first section.

In yet another embodiment of the present invention, the foldable frame is made from a biodegradable material.

In still another embodiment of the present invention, the foldable frame has a score line separating the handle from the back edge of the first section.

In an embodiment, the foldable frame has been sprayed with a fragrance.

In an embodiment, the foldable frame has an adhesive strip for securing the foldable frame.

In still another embodiment, the first section of the foldable frame is rotated with respect to the second section.

In another embodiment, the first side panel of the foldable frame rotates from a substantially planer configuration with the second section to a substantially perpendicular configuration with the second section.

In yet another embodiment of the present invention, the second side panel rotates from a substantially planer configuration with the second section to a substantially perpendicular configuration with the second section.

In an embodiment, the first section rotates from a substantially planer configuration with the second section to a substantially perpendicular configuration with the second section.

In an embodiment, the second section is substantially square is shape.

In yet another embodiment, the foldable frame is substantially planar.

In still another embodiment, directions for folding the foldable frame are printed directly on the foldable frame.

In an embodiment, the frame is resistant to the absorption of liquids.

In another embodiment, the main handle section of the foldable frame has a length between three and eight inches.

In an embodiment, the removable section has a smaller surface area than the second section.

In yet another embodiment, the second section has a larger surface area than the first section.

In yet another embodiment, the main handle section has a first subpanel and a second subpanel wherein the first subpanel and second subpanel are separated from the main handle section by a first score line and a second score line; respectively.

Finally, in another embodiment, the main handle section has a first subpanel and a second subpanel and wherein the first subpanel and second subpanel are separated from the main handle section by score lines and further, wherein the first subpanel and second subpanel rotate from a position substantially planar with the main handle section to a position substantially perpendicular to the main handle section.

It is, therefore, an advantage of the present invention to provide a novel scoop device.

A further advantage of the present invention is to provide a novel scoop device which may be transported and/or stored in a flat configuration prior to use.

Yet another advantage of the present invention is to provide a novel scoop device which is economical to produce and, therefore, may be used once and then discarded.

An advantage of the present invention is to produce a scoop which is light-weight and small enough to be carried in, for example, a pocket or purse prior to use. The scoop may be carried easily in the folded configuration, in the flat configuration, or in a non-functional folded configuration.

A still further advantage of the present invention is to provide a scoop which may be dispensed in coin operated machines or the like.

Yet another advantage of the present invention is to provide a scoop which has a fragrance or fights unpleasant odors.

Another advantage of the present invention is to provide a foldable frame which converts into a functional scoop by the use of score lines.

A still further advantage of the present invention is to provide a foldable frame, which converts into a functional scoop, that has folding directions printed on the foldable frame.

For a more complete understanding of the above listed features and advantages of the scoop, reference should be made to the following detailed description of the preferred embodiments and to the accompanying drawings. Further, additional features and advantages of the present invention are described in, and will be apparent from, the detailed description of the preferred embodiments and from the drawings.

### BRIEF DESCRIPTION OF THE DRAWINGS

FIG. 1 illustrates a side perspective view of the scoop in a folded configuration.

FIG. 2 illustrates a top flat view of the a foldable frame in a flat configuration.

FIG. 3 illustrates a side perspective view of a partially folded scoop of the present invention.

FIG. 4 illustrates a side perspective view of a partially folded scoop of the present invention.

### DETAILED DESCRIPTION OF THE PREFERRED EMBODIMENTS

The present invention generally provides a foldable frame for creating a scoop. The foldable frame for creating a scoop may be constructed from a semi-rigid material, such as, for example, cardboard, which may be both durable and foldable. The scoop may be used once and discarded or used for as long as the person desires. The scoop further has a removable section which may aid the user in the picking up of, for example, animal fecal waste.

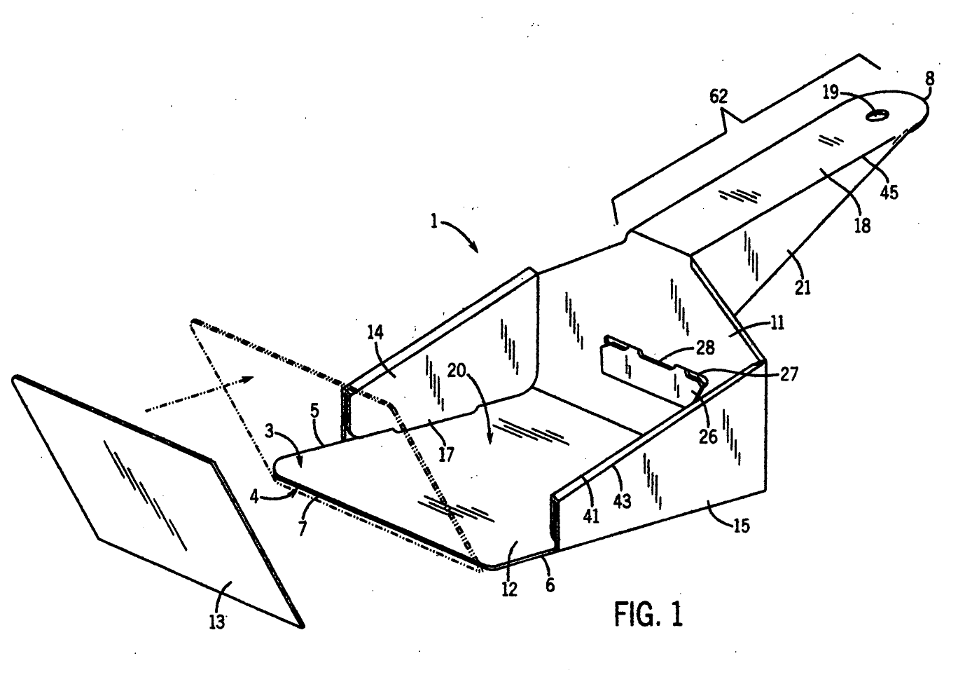

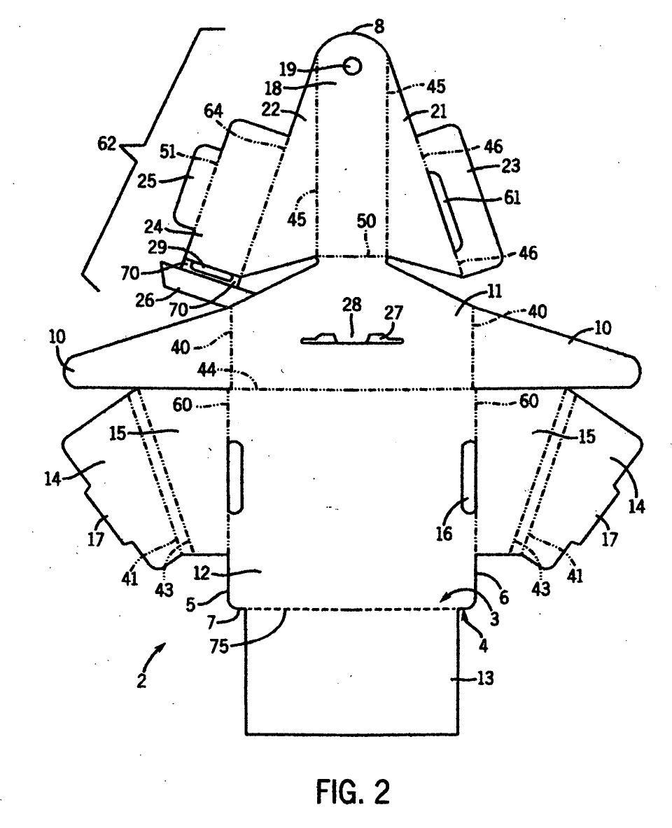

Referring to the drawing wherein like numerals refer to like parts, FIG. 1 illustrates a scoop 1 for picking up waste, for example, animal fecal waste. The scoop 1 has an opening 20 which receives the waste. The scoop 1 may be suitable for use outside in, for example, a park or backyard, or may be used indoors in, for example, a litter box. The scoop 1 is converted from a foldable frame 2 (as illustrated in FIG. 2). In the preferred embodiment, the scoop 1 may be made from cardboard, however, the scoop 1 may be made from, for example, plastic, metal, wood, heavy paper or any other suitable material. The foldable frame 2 may be a single sheet which may be semi-rigid, yet still has flexibility and the capacity to be scored and folded.

The foldable frame 2 is preferably light weight and, as such, suitable for carrying on walks. The foldable frame 2 or the functional scoop 1 may be small and may fit in most purses, backpacks or other common carrying devices. If the user has limited space in which to carry the scoop 1 while on, for example, a walk, the foldable frame 2 may be transported compactly in a non-functional folded configuration and later converted into the functional scoop configuration.

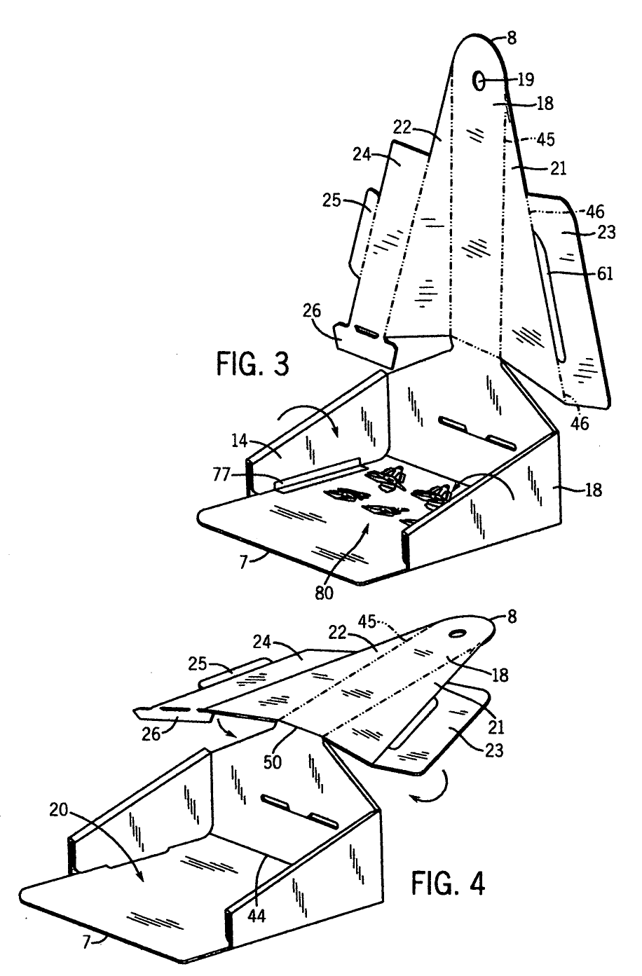

In production of the foldable frame 2, a fragrance or odor reducing chemical may be added to reduce the unwanted odor of, for example, the animal waste. Alternatively, a fragrance or odor reducing chemical may be added to the foldable frame 2 or functional scoop 1 after production. In addition, the invention may have folding directions 80 printed directly on the foldable frame 1 (As illustrated in FIG. 3). The folding directions 80 may be, for example, written directions and/or a diagram(s). Printing the folding directions 80 directly on the foldable frame 2 may eliminate the problem of loosing the folding directions. Further, it may allow the user to give the foldable frame 2 to another person without the need to provide the person with a folding manual.

Referring now to FIGS. 2-4, while in the substantially flat configuration (FIG. 2), the foldable flame 2 has a top 3, a bottom 4, a first side 5, a second side 6, a front 7 and a back 8. As visible in FIG. 2, the length of the foldable frame 2 may be greater than the width of the foldable frame 2. The foldable frame 2 may be folded into the second configuration, as illustrated in FIG. 1.

The foldable frame 2 has a plurality of score lines which enable the numerous sections of the foldable flame 2 to be rotated into the functional second configuration. More specifically, the foldable flame 2 has a first section 11 which may be folded upward approximately ninety degrees toward the top 3 of the foldable frame 2 via a single score line 44 which separates the first section 11 from a second section 12. After the first section 11 has been rotated upward toward the top 3 of the foldable frame 2 and is in the upright position, at least a pair of symmetrical side supports 10 may be rotated forward toward the front 7 of the foldable frame 2 around a first pair of symmetrical score lines 40.

Extending from the second section 12, toward the first side 5 and the second side 6 of the foldable frame 2; respectively, may be a pair of symmetrical side panels 15. The symmetrical side panels 15 may be located closer to the front 7 of the foldable frame 2 than the side supports 10. The side panels 15 may be rotated approximately ninety degrees upward via a second pair of symmetrical score lines 60. After being rotated upward toward the top 3 of the foldable frame 2, the side panels 15 may lay flat against the side supports 10 which have previously been rotated toward the front 7 of the foldable frame 2. A third pair of symmetrical score lines 43 and fourth pair of symmetrical score lines 41 may then allow a pair of symmetrical interior panels 14 to be folded over the side supports 10 and substantially cover the side supports 10. More specifically, the interior side panels 14 may rotate approximately one hundred and eighty degrees with respect to the side panels 15.

A pair of tabs 17 on the outermost portion of the interior panels 14 may then be secured into a pair of symmetrical tab receivers 16 located within the second section 12. More specifically, the tab receivers 16 may be located within the second section 12, near the first side 5 and second side 6 of the foldable frame 2. The tabs 17 may be secured into the pair of tab receivers 16 by, for example, friction. After the scoop 1 is properly folded and the tabs 17 are properly secured into the tab receivers 16, the side supports 10, the side panels 15 and the interior panels 14 align in a substantially parallel position to each other. The use of the tabs 17 and tab receivers 16 of the scoop 1 allow the securing of the scoop 1 into the functional configuration without the need for an adhesive or other securing devices. Preferably, the tab receivers 16 have the approximately the same, or a slightly larger, length than the tabs 17. Further, the tabs 17 may be removed from the tab receivers 16 if the user wishes to change the scoop 1 from the functional configuration of FIG. 1 into the flat configuration of FIG. 2 for the purpose of, for example, storage.

While the tabs 17 are inserted into the tab receivers 16, the interior panels 14 act as the sides of the scoop 1 and help prevent the waste from falling out of the scoop 1. In the preferred embodiment the tabs 17 allow the foldable frame 2 to be secured into the functional scoop 1 configuration without the need for an adhesive strip 77 or other securing device, such as, a wire. However, in alternative embodiments, an adhesive strip 77 or other securing device may be implemented.

The scoop 1 may also have a handle 62 having a main handle section 18 which may be folded backward from the first section 11 at a back score line 50. The back score line 50 may be substantially parallel to the single score line 44 while the scoop 1 is in either the flat or folded configurations. The main handle section 18 may have a first side panel 21 and a second side panel 22. The first side panel 21 and the second side panel 22 may each be attached to the main handle section 18 by a pair of symmetrical score lines 45. The main handle section 18 may have an opening 19 which may, for example, allow the scoop 1 to be hung from, for example, a hook in either the substantially flat or folded configurations. Alternatively, the opening 19 may be used to secure a plastic bag (not shown) into the scoop 1.

The first side panel 21 of the handle 62 may have an opening 61 and a wing 23. The wing 23 may be located further away from the main handle section 18 than the first side panel 21 while the scoop 1 is in the substantially flat configuration. The wing 23 may be rotated downward approximately ninety degrees with respect to the first side panel 21 via a score line 46. A section of the score line 46, specifically the section in which the opening 61 may be present, completely lacks any connection between the first side panel 21 and the wing 23.

The second side panel 22 of the handle 62 may have a wing section 24 attached thereto via a score line 64. The score line 64 may allow the wing section 24 to rotate downward approximately ninety degrees with respect to the second side panel 22. The wing section 24 of the second panel 22 may have a first tab 25 and a second tab 26. The first tab 25 may be located further away from the main handle section 18 than the wing 24 while the scoop 1 is in the substantially flat configuration. The first tab 25 may be separated from the wing section 24 by a score line 51. More specifically, the score line 51 may allow the first tab 25 to rotate downward approximately ninety degrees with respect to the wing section 24.

The second tab 26 of the wing section 24 may be located closer to the front 7 of the scoop 1 then the wing section 24 while the scoop 1 is in the substantially flat configuration. A substantially rectangular slot 29 may be present between the wing section 24 and the second tab 26. Preferably, the long sides of the rectangular slot 29 are substantially parallel to the long sides of the second tab 26.

The second tab 26 may be attached to the wing section 24 by a pair of substantially similar connectors 70. More specifically, the rectangular slot 29 may be located between the substantially similar connectors 70.

To fold the handle 62 into a functional configuration, the wing 23 may be folded approximately ninety degrees downward with respect to the first side panel 21. The first side panel 21 may be itself then rotated approximately ninety degrees downward with respect to the main handle section 18.

The first tab 25 of the wing section 24 may be rotated downward approximately ninety degrees with respect to the wing section 24 along the score line 51. Following this, the wing section 24 may be rotated approximately ninety degrees downward with respect to the second side panel 22 along the score line 64. Next, the second side panel 22 may be rotated downward approximately ninety degrees with respect to the main handle section 18 along score line 45. Upon rotating the second side panel 22 around the score line 45, the first tab 25 of the wing section 24 will substantially align with the opening 61. The first tab 25 may then be inserted into the opening 61 and secured by, for example, friction. While the first tab 25 is inside of the opening 61, the first tab 25 will be substantially obscured from view by the first side panel 21.

To finally place the scoop 1 into the functional configuration, the second tab 26 of the wing section 24 may be inserted into an opening 27 within the first section 11. To properly secure the second tab 26 of the wing section 24 within the opening 27 of the first section 11, the opening 27 of the first section 11 may be divided by a center tab 28 which locks into the rectangular slot 29.

While in the functional configuration, the handle 62 acts as a sturdy means to support and carry the scoop 1, either empty or filled with waste material. The handle 62 of the scoop 1 is preferable between three and eight inches long to comfortably accommodate the size of an average human hand; however the length of the handle 62 may vary depending on what purpose a particular scoop 1 is constructed for or may vary depending on the size of larger or smaller users.

The front 7 of the scoop 1 has a removable section 13 attached to the second section 12 by a tear line 75. When the user pulls on the removable section 13 of the scoop 1, the force along the tear line 75 causes the tear line 75 to break and completely separate the removable section 13 from the second section 12. The user may then scoop up waste, for example, animal fecal waste, by using the removable section 13 to push the waste into the opening 20 of the scoop 1. Utilizing the removable section 13 to push the waste into the opening 20 of the scoop 1 may allow the user to avoid touching the waste with the user's own hand. The user may then discard the removable section 13, the waste and the scoop 1. Alternatively, the user may use the functional scoop 1 without removing the removable section 13 from the second section 12. Still further, the user may use the functional scoop 1 to scoop up waste after removing the removable section 13 from the second section 12, but without utilizing the removable section 13 to push the waste into the scoop 1.

Although steps for folding the foldable frame 2 into the functional scoop 1 are described above, it should be understood that other folding steps or other sequences of the same steps may be implemented to accomplish the same or a similar functional scoop. For example, the user may elect to fold the sections of the handle prior to the folding of the first section 11 with respect to the second section 12.

Although embodiments of the present invention are shown and described therein, it should be understood that various changes and modifications to the presently preferred embodiments will be apparent to those skilled in the art. Such changes and modifications may be made without departing from the spirit and scope of the present invention and without diminishing its attendant advantages. It is, therefore, intended that such changes and modifications be covered by the appended claims.

1. A foldable frame for forming a scoop comprising:
a first section having a first edge, a second edge, a front edge and a back edge;
a second section attached to the front edge of the first section wherein the second section is separated from the first section by a score line and wherein the second section has a top surface;
a main handle section attached to the back edge of the first section;
a first side panel and a second side panel attached to the second section; and
a removable section attached to the second section wherein the removable section is separated from the second section by a score line and wherein the removable section is completely removed from the second section and is used to scoop material onto the top surface of the second section.

2. The foldable frame of claim 1 further comprising:
an opening in the main handle section.

3. The foldable frame of claim 1 further comprising:
an opening in the first section.

4. The foldable frame of claim 1 wherein the foldable frame is made from a biodegradable material.

5. The foldable frame of claim 1 further comprising:
a score line separating the main handle section from the back edge of the first section.

6. The foldable frame of claim 1 wherein the foldable frame has been sprayed with a fragrance.

7. The foldable frame of claim 1 further comprising:
an adhesive strip for securing the foldable frame.

8. The foldable frame of claim 1 wherein the first section is rotated with respect to the second section.

9. The foldable frame of claim 1 wherein the first side panel rotates from a substantially planer configuration with the second section to a substantially perpendicular configuration with the second section.

10. The foldable frame of claim 1 wherein the second side panel rotates from a substantially planer configuration with the second section to a substantially perpendicular configuration with the second section.

11. The foldable frame of claim 1 wherein the first section rotates from a substantially planer configuration with the second section to a substantially perpendicular configuration with the second section.

12. The foldable frame of claim 1 wherein the second section is substantially square is shape.

13. The foldable frame of claim 1 wherein the foldable frame is substantially planar.

14. The foldable frame of claim 1 further comprising:
directions for folding the foldable frame printed directly on the foldable frame.

15. The foldable frame of claim 1 wherein the frame from made of a material which is resistant to the absorption of liquids.

16. The foldable frame of claim 1 wherein the main handle section has a length between three and eight inches.

17. The foldable frame of claim 1 wherein the removable section has a smaller surface area than the second section.

18. The foldable frame of claim 1 wherein the second section has a larger surface area than the first section.

19. The foldable frame of claim 1 wherein the main handle section comprises:
a first subpanel; and
a second subpanel and wherein the first subpanel and second subpanel are separated from the main handle section by a first score line and a second score line; respectively.

20. The main handle section of claim 19 wherein the first subpanel and second subpanel rotate from a position substantially planar with the main handle section to a position substantially perpendicular to the main handle section.
